(19) United States
(12) Patent Application Publication
(10) Pub. No.: US 2022/0092675 A1
(43) Pub. Date: Mar. 24, 2022

(54) INFORMATION PROCESSING APPARATUS AND PROGRAM

(71) Applicant: TOSHIBA TEC KABUSHIKI KAISHA, Tokyo (JP)

(72) Inventor: Nobuyuki MARUMO, Izu Shizuoka (JP)

(73) Assignee: TOSHIBA TEC KABUSHIKI KAISHA, Tokyo (JP)

(21) Appl. No.: 17/330,292

(22) Filed: May 25, 2021

(30) Foreign Application Priority Data
Sep. 18, 2020 (JP) 2020-157617

(51) Int. Cl. G06Q 30/06; G10L 15/18

(52) U.S. Cl. CPC G06Q 30/0633; G06Q 30/0625; G10L 2015/088; G10L 15/1822; G10L 15/1815

(57) ABSTRACT

In an information processing apparatus according to at least one embodiment, a controller is configured to correlate a request of a customer for a commodity with information (for example, an image, a commodity code, and a commodity name of the commodity) for specifying the commodity for which the request is made and to acquire the request. The controller is configured to analyze, for each commodity, the request acquired based on whether a preset keyword is included in the request, and to transmit an analysis result to a transmission destination (for example, a producer of the commodity) correlated with the commodity.

### CROSS-REFERENCE TO RELATED APPLICATION

This application is based upon and claims the benefit of priority from Japanese Patent Application No. 2020-157617, filed on Sep. 18, 2020, the entire contents of which are incorporated herein by reference.

### FIELD

Embodiments described herein relate generally to an information processing apparatus and a program.

### BACKGROUND

Stores and producers collect and make use of impressions and requests about commodities currently on sale respectively in order to learn what kinds of commodities will be sold more in the future and in order to develop commodities that will be sold more than commodities currently being produced.

However, in general, such collection of views is often based on questionnaires created by the store and the producer (for example, JP-A-2017-62672 (Patent Literature 1)).

On the other hand, if consumers have dissatisfaction with purchased commodities, the consumers sometimes transmit requests for the commodities using WEB (World Wide Web) sites and SNSs (Social Networking Services) in order to purchase better commodities.

In order to collect such impressions and requests of the consumers, the stores and the producers need to collect desired information referring to the WEB sites and the SNSs for which the consumers register. However, it takes time to select only necessary information out of a huge amount of information.

### DESCRIPTION OF THE DRAWINGS

FIG. 1 is a system configuration diagram illustrating an example of the configuration of a request analysis system in at least one embodiment;

FIG. 2 is a hardware block diagram illustrating an example of a hardware configuration of a store server in at least one embodiment;

FIG. 3 is a hardware block diagram illustrating an example of a hardware configuration of a portable terminal in at least one embodiment;

FIG. 4 is a functional block diagram illustrating an example of a functional configuration of a store server in at least one embodiment;

FIG. 5 is a functional block diagram illustrating an example of a functional configuration of the portable terminal;

FIG. 6 is a diagram illustrating an example of a screen displayed on the portable terminal and showing a result of object recognition;

FIG. 7 is a diagram illustrating an example of a screen showing commodity information of a recognized commodity;

FIG. 8 is a diagram illustrating an example of a screen showing a request input by voice;

FIGS. 9A and 9B are diagrams illustrating an example of words to be registered in order to analyze a request;

FIG. 10 is a diagram illustrating an example of an analysis result of the request;

FIG. 11 is a diagram illustrating an example of a producer list including transmission destinations of the request;

FIG. 12 is a flowchart illustrating an example of a flow of processing performed by the portable terminal;

FIG. 13 is a flowchart illustrating an example of a flow of a request input process performed by the portable terminal;

FIG. 14 is a flowchart illustrating an example of a flow of a commodity registering process and a settlement process performed by the portable terminal;

FIG. 15 is a flowchart illustrating an example of a flow of processing performed by the store server; and

FIG. 16 is a flowchart illustrating an example of a flow of a request recognizing process performed by the store server.

### DETAILED DESCRIPTION

In order to solve the problem described above, an information processing apparatus and a program that can easily acquire customers' requests for commodities using words of the customers is provided.

An information processing apparatus according to at least one embodiment includes an acquiring unit (e.g., an acquiring device), an analyzing unit (e.g., an analyzing device), and a transmitting unit (e.g., a transmitter). The acquiring unit correlates a request of a customer for a commodity with information for specifying the commodity for which the request is made and acquires the request. The analyzing unit analyzes, for each commodity, the request acquired by the acquiring unit based on whether a preset word is included in the request. The transmitting unit transmits an analysis result by the analyzing unit to a transmission destination correlated with the commodity.

### Embodiment

A request analysis system 10 according to at least one embodiment is explained.

Overall Configuration of the Request Analysis System:

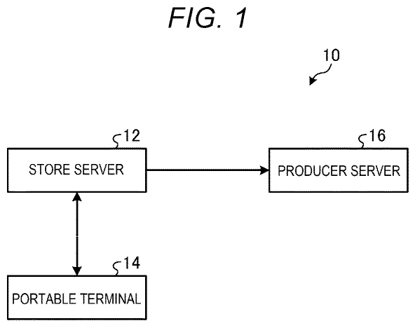

First, an overall configuration of the request analysis system 10 is explained with reference to FIG. 1. FIG. 1 is a system configuration diagram illustrating an example of the configuration of the request analysis system in at least one embodiment.

The request analysis system 10 includes a store server 12, a portable terminal 14, and a producer server 16.

The store server 12 is connected to the portable terminal 14 by wireless communication. The store server 12 acquires, from the portable terminal 14, settlement information indicating content settled by the portable terminal 14. The store server 12 acquires a request for a commodity input by the customer using the portable terminal 14. The store server 12 analyzes content of the request for the commodity input by the customer. The store server 12 transmits an analysis result of the request to a destination correlated with a producer of the commodity. The store server 12 is an example of the information processing apparatus in the present disclosure.

The portable terminal 14 is carried by a customer registered as a member in a store. The portable terminal 14 functions as a so-called smartphone POS (Point Of Sales) that performs, if the customer purchases a commodity in the store, settlement relating to the purchased commodity. The portable terminal 14 receives, based on operation by the customer, an input of a request for a commodity selected by the customer. The customer may select a commodity by photographing, with a camera included in the portable terminal 14, an image of a commodity for which the customer desires to input a request or may select a commodity by connecting the portable terminal 14 to the Internet and performing information retrieval by a keyword input or the like.

The customer may input a request for the selected commodity by speaking to the portable terminal 14 or may input the request as a text using a touch panel of the portable terminal 14.

The producer server 16 is communicably connected to the store server 12. The producer server 16 correlates the request for the commodity analyzed by the store server 12 with the commodity and acquires the request from the store server 12.

Hardware Configuration of the Store Server

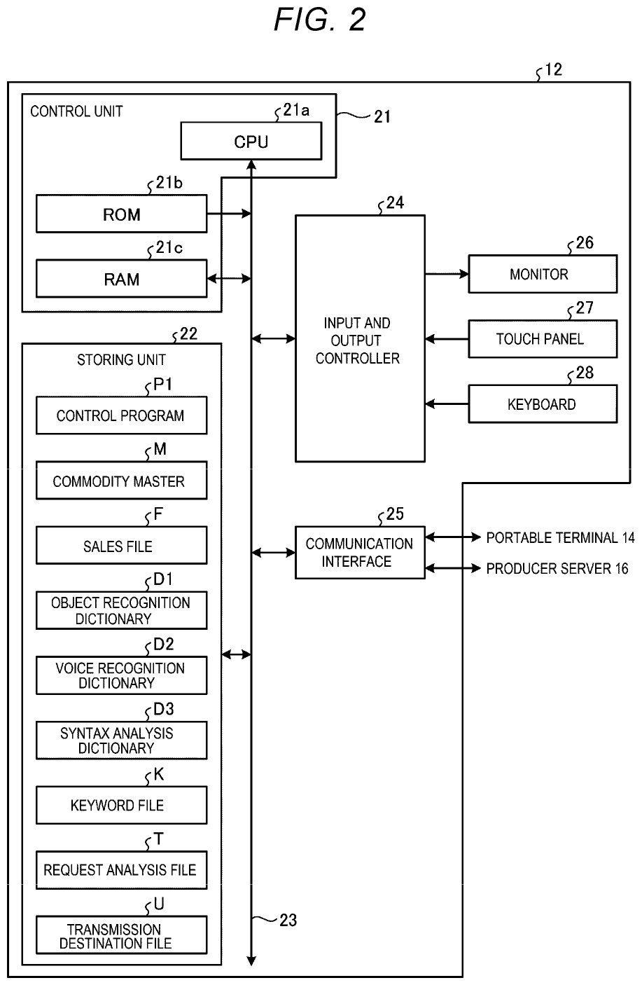

A hardware configuration of the store server 12 is explained with reference to FIG. 2. FIG. 2 is a hardware block diagram illustrating an example of a hardware configuration of the store server in at least one embodiment.

The store server 12 includes a control unit 21 (e.g., a controller), a storing unit 22 (e.g., a memory), an input and output controller 24, and a communication interface 25.

The control unit 21 has the configuration of a general computer including a CPU (Central Processing Unit) 21a, a ROM (Read Only Memory) 21b, and a RAM (Random Access Memory) 21c. The CPU 21a reads out various programs, a data file, and the like stored in the ROM 21b or the storing unit 22 explained below and loads the computer programs, the data file, and the like in the RAM 21c. The CPU 21a operates according to the programs, the data file, and the like loaded in the RAM 21c and manages control of the entire store server 12.

The control unit 21 is connected to the storing unit 22, the input and output controller 24, and the communication interface 25 via an internal bus 23.

The storing unit 22 retains stored information even if a power supply is turned off. The storing unit 22 is, for example, a HDD (Hard Disk Drive). The store server 12 may include a nonvolatile memory such as a flash memory instead of the HDD. The storing unit 22 stores programs and the like including a control program P1. The control program P1 is a program for causing the store server 12 to exert the functions of the store server 12.

The control program P1 may be incorporated in the ROM 21b in advance and provided. The control program P1 may be provided to the control unit 21 while being recorded in a computer-readable recording medium such as a CD-ROM, a flexible disk (FD), a CD-R, or a DVD (Digital Versatile Disc) as a file of an installable format or an executable format. Further, the control program P1 may be stored on a computer connected to a network such as the Internet and provided by being downloaded through the network. The control program P1 may be provided or distributed through a network such as the Internet.

The storing unit 22 further stores a commodity master M, a sales file F, an object recognition dictionary D1, a voice recognition dictionary D2, a syntax analysis dictionary D3, a keyword file K, a request analysis file T, and a transmission destination file U.

The commodity master M is a master file that stores commodity information such as names and unit prices of commodities in association with commodity codes. The commodity master M is updated at any time according to commodities arriving at the store by performing communication with a not-illustrated host server connected to the store server 12.

The sales file F is a file storing detailed information of sales for each settlement. The sales file F includes at least identification information for identifying a customer, a purchase date of a commodity, commodity identification information for uniquely specifying the commodity, the number of purchased items, a unit price, a total amount excluding tax, a total amount including tax, and a settlement method. The settlement method indicates a settlement method such as electronic money settlement or credit card settlement.

The object recognition dictionary D1 is a dictionary used to uniquely specify a commodity indicated by an image of the commodity transmitted from the portable terminal 14. Characteristics of the exterior of the commodity are registered in the dictionary.

The voice recognition dictionary D2 is various dictionaries used to recognize voice input by the customer and transmitted from the portable terminal 14. In order to perform voice recognition, in general, an acoustic model, a word model, and a language model are used. The acoustic model is a model for extracting phonemes out of an input voice signal. The word model is a model for specifying words from a combination of the phonemes extracted using the acoustic model. The word model is a model for analyzing a link among the specified words and completing a sentence.

The syntax analysis dictionary D3 is a dictionary used in order to perform a syntax analysis of a structure of a sentence recognized by voice. In general, a grammatical rule is used in order to perform the syntax analysis.

The keyword file K is a file storing various words assumed to be included in the request of the customer. The keyword file K is explained in detail below.

The request analysis file T is a file storing a result obtained by analyzing types, appearance frequencies, and the like of words included in the request of the customer. The request analysis file T is explained in detail below.

The transmission destination file U is a file correlating a transmission destination of the request analysis file T with the commodity and storing the transmission destination. The transmission destination file U is explained in detail below.

The input and output controller 24 connects the control unit 21, a monitor 26, which is an input and output device, a touch panel 27, and a keyboard 28.

The monitor 26 displays various kinds of image information output by the store server 12.

The touch panel 27 and the keyboard 28 input various kinds of operation information to the store server 12.

The communication interface 25 establishes wireless connection between the communication interface 25 and the portable terminal 14. The store server 12 receives authentication information and settlement information of the customer from the portable terminal 14. The store server 12 acquires, from the portable terminal 14, the request for the commodity input by the customer. The communication interface 25 establishes wireless connection between the communication interface 25 and the producer server 16. The store server 12 transmits the request analysis file T to the producer server 16 correlated with the commodity included in the request analysis file T.

Hardware Configuration of the Portable Terminal:

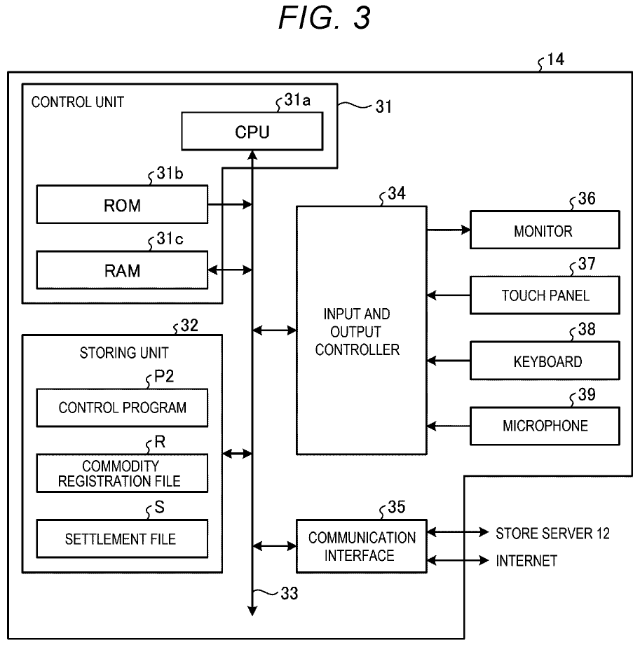

A hardware configuration of the portable terminal 14 is explained with reference to FIG. 3. FIG. 3 is a hardware block diagram illustrating an example of a hardware configuration of the portable terminal in at least one embodiment.

The portable terminal 14 includes a control unit 31 (e.g., a controller), a storing unit 32 (e.g., a memory), an input and output controller 34, and a communication interface 35.

The control unit 31 has the configuration of a general computer including a CPU 31a, a ROM 31b, and a RAM 31c. The CPU 31a reads out various programs, a data file, and the like stored in the ROM 31b or the storing unit 32 explained below and loads the various programs, the data file, and the like in the RAM 31c. The CPU 31a operates according to the various programs, the data file, and the like loaded in the RAM 31c and manages control of the entire portable terminal 14.

The control unit 31 is connected to the storing unit 32, the input and output controller 34, and the communication interface 35 via an internal bus 33.

The storing unit 32 retains stored information even if a power supply is turned off. The storing unit 32 is, for example, a HDD. The portable terminal 14 may include a nonvolatile memory such as a flash memory instead of the HDD. The storing unit 32 stores programs and the like including a control program P2. The control program P2 is a program for causing the portable terminal 14 to exert the functions of the portable terminal 14.

The storing unit 32 further stores a commodity registration file R and a settlement file S.

The commodity registration file R is a file in which a commodity to be purchased by the customer is registered. The commodity registration file R includes at least commodity identification information for uniquely specifying the commodity, the number of purchased items, a unit price, and a total amount excluding tax.

The settlement file S is a file in which settlement content relating to the commodity to be purchased by the customer is registered. The settlement file S includes at least identification information for identifying the customer, a purchase date of the commodity, commodity identification information for uniquely specifying the commodity, the number of purchased items, a unit price, a total amount excluding tax, a total amount including tax, and a settlement method.

The input and output controller 34 connects the control unit 31, a monitor 36, which is an input and output device, a touch panel 37, a camera 38, and a microphone 39.

The monitor 36 displays various kinds of image information output by the portable terminal 14.

The touch panel 37 inputs various kinds of operation information to the portable terminal 14. A plurality of buttons such as a closing button for instructing a start of a settlement process, for example, if registration of all commodities to be purchased by the customer is completed are allocated to the touch panel 37.

If the customer registers a commodity to be purchased, the camera 38 reads a code symbol such as a barcode attached to the commodity. The camera 38 is a sensor incorporated in the portable terminal 14 and including an imaging element such as a CCD or a CMOS.

The microphone 39 detects utterance of the customer and converts the utterance into a voice signal. The converted voice signal is temporarily stored in the portable terminal 14.

The communication interface 35 establishes wireless communication between the portable terminal 14 and the store server 12. The communication interface 35 connects the portable terminal 14 to the Internet.

Functional Configuration of the Store Server:

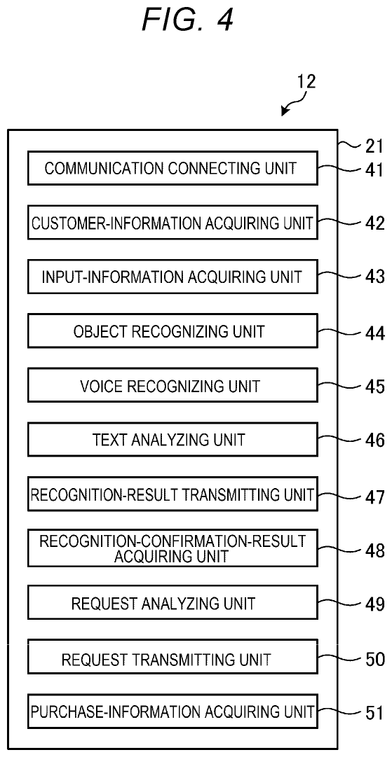

A functional configuration of the store server 12 is explained with reference to FIG. 4. FIG. 4 is a functional block diagram illustrating an example of a functional configuration of the store server in at least one embodiment.

The control unit 21 of the store server 12 loads the control program P1 in the RAM 21c and causes the control program P1 to operate to thereby realize, as functional units, a communication connecting unit 41, a customer-information acquiring unit 42, an input-information acquiring unit 43, an object recognizing unit 44, a voice recognizing unit 45, a text analyzing unit 46, a recognition-result transmitting unit 47, a recognition-confirmation-result acquiring unit 48, a request analyzing unit 49, a request transmitting unit 50, and a purchase-information acquiring unit 51 illustrated in FIG. 4.

The communication connecting unit 41 establishes wireless communication between the communication connecting unit 41 and the portable terminal 14.

The customer-information acquiring unit 42 reads customer information transmitted from the portable terminal 14 to thereby perform an authentication process for authenticating that the customer is a member of the store. Specifically, if the customer enters the store, the customer reads, with the camera 38 of the portable terminal 14, a code symbol such as a QR code (registered trademark) set in the entrance of the store. If the authentication processing is successful, the store server 12 and the portable terminal 14 are wirelessly connected. The customer-information reading unit 52 reads customer information (for example, a customer ID) stored in the portable terminal 14.

The input-information acquiring unit 43 correlates a request of the customer for a commodity with information for specifying the commodity for which the request is made and acquires the request. Specifically, the input-information acquiring unit 43 acquires, from the portable terminal 14, an image of the commodity for which the request is made acquired by the portable terminal 14 and the request of the customer for the commodity. The request of the customer may be a voice signal uttered by the customer or text information input to the portable terminal 14 by the customer. The image of the commodity may be text information including a commodity name capable of uniquely specifying the commodity. The input-information acquiring unit 43 is an example of the acquiring unit in the present disclosure.

The object recognizing unit 44 uniquely specifies, using the object recognition dictionary D1, the commodity photographed in the image transmitted from the portable terminal 14. A result of specifying the commodity is output as, for example, a commodity code or a commodity name.

The voice recognizing unit 45 recognizes, using the voice recognition dictionary D2, voice of the customer transmitted from the portable terminal 14.

The text analyzing unit 46 performs so-called dictation for performing a syntax analysis of the request of the customer recognized by the voice recognizing unit 45 to thereby write the request as a sentence.

The recognition-result transmitting unit 47 transmits recognition results of the object recognizing unit 44 and the voice recognizing unit 45 to the portable terminal 14.

The recognition-confirmation-result acquiring unit 48 acquires a confirmation result of the customer for the recognition results transmitted to the portable terminal 14 by the recognition-result transmitting unit 47.

The request analyzing unit 49 analyzes, for each commodity, an appearance frequency of a preset word included in the request of the customer. The request analyzing unit 49 is an example of the analyzing unit in the present disclosure.

The request transmitting unit 50 transmits an analysis result of the request analyzing unit 49 to the transmission destination correlated with the commodity. The request transmitting unit 50 is an example of the transmitting unit in the present disclosure.

The purchase-information acquiring unit 51 acquires a result of the registration and the settlement of the commodity to be purchased performed by the customer using the portable terminal 14. More specifically, if the settlement is completed, the purchase-information acquiring unit 51 acquires the commodity registration file R and the settlement file S from the portable terminal 14.

Functional Configuration of the Portable Terminal:

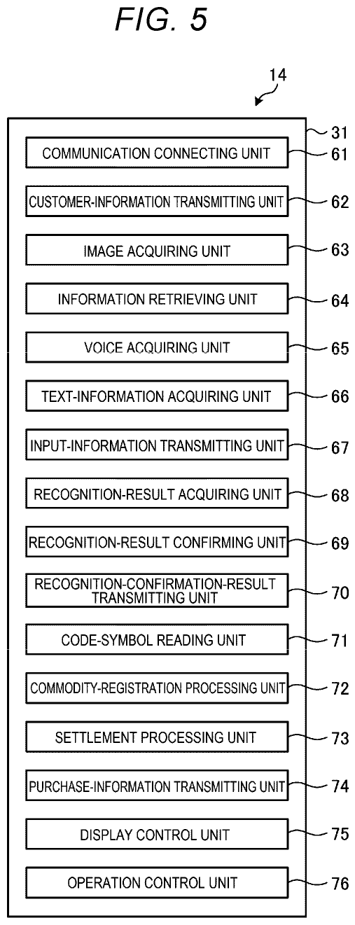

A functional configuration of the portable terminal 14 is explained with reference to FIG. 5. FIG. 5 is a functional block diagram illustrating an example of a functional configuration of the portable terminal in at least one embodiment.

The control unit 31 of the portable terminal 14 loads the control program P2 in the RAM 21c and causes the control program P2 to operate to thereby realize, as functional units, a communication connecting unit 61, a customer-information transmitting unit 62, an image acquiring unit 63, an information retrieving unit 64, a voice acquiring unit 65, a text-information acquiring unit 66, an input-information transmitting unit 67, a recognition-result acquiring unit 68, a recognition-result confirming unit 69, a recognition-confirmation-result transmitting unit 70, a code-symbol reading unit 71, a commodity-registration processing unit 72, a settlement processing unit 73, a purchase-information transmitting unit 74, a display control unit 75, and an operation control unit 76.

The communication connecting unit 61 establishes wireless communication between the communication connecting unit 61 and the store server 12.

For authentication, the customer-information transmitting unit 62 transmits customer information (for example, a customer ID) to the store server 12.

The image acquiring unit 63 acquires, with the camera 38, an image of the commodity for which the request is made.

The information retrieving unit 64 retrieves, from the Internet or the like, the commodity for which the request is made.

The voice acquiring unit 65 acquires, with the microphone 39, the request of the customer for the commodity as a voice signal.

The text-information acquiring unit 66 acquires, as text information, the request of the customer for the commodity input by the touch panel 37.

The input-information transmitting unit 67 transmits, to the store server 12, the image of the commodity, the voice signal, or the text information acquired by the portable terminal 14.

The recognition-result acquiring unit 68 acquires, from the store server 12, the recognition result of the image of the commodity by the object recognizing unit 44 and the recognition result of the utterance of the customer by the voice recognizing unit 45 and the text analyzing unit 46.

The recognition-result confirming unit 69 displays, on the monitor 36, the recognition result acquired by the recognition-result acquiring unit 68. The recognition-result confirming unit 69 requests the customer to confirm the recognition result. The recognition-result confirming unit 69 acquires a confirmation result of the customer.

The recognition-confirmation-result transmitting unit 70 transmits the recognition result confirmed by the recognition-result confirming unit 69 to the store server 12.

The code-symbol reading unit 71 reads, using the camera 38, the code symbol such as the barcode attached to the commodity to be purchased by the customer.

The commodity-registration processing unit 72 collates the commodity code recorded in the code symbol read by the code-symbol reading unit 71 and the commodity master M to thereby uniquely specify the commodity to be purchased by the customer. The commodity-registration processing unit 72 registers the uniquely specified commodity as a purchased commodity and generates the commodity registration file R. The commodity-registration processing unit 72 transmits the commodity code to the store server 12. The store server 12 collates the commodity code and the commodity master M. The portable terminal 14 acquires a collation result from the store server 12.

For example, if detecting that the closing button of the touch panel 37 is pressed, the settlement processing unit 73 performs settlement for the commodity registered at that point in time. The settlement processing unit 73 generates the settlement file S.

The purchase-information transmitting unit 74 transmits the commodity registration file R generated by the commodity-registration processing unit 72 and the settlement file S generated by the settlement processing unit 73 to the store server 12.

The display control unit 75 outputs, to the monitor 36, image information corresponding to the processing performed by the units explained above.

The operation control unit 76 detects the operation performed on the touch panel 37 to thereby cause the portable terminal 14 to perform control corresponding to the performed operation.

Method of Inputting a Request for a Commodity:

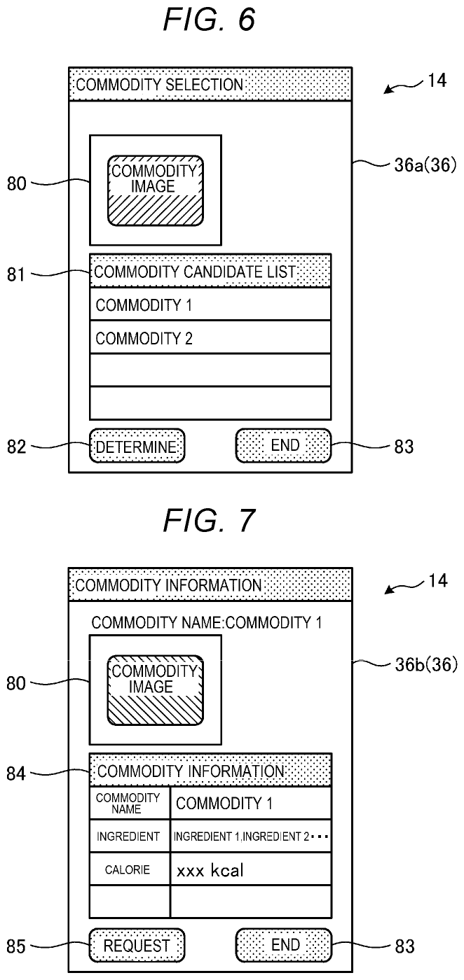

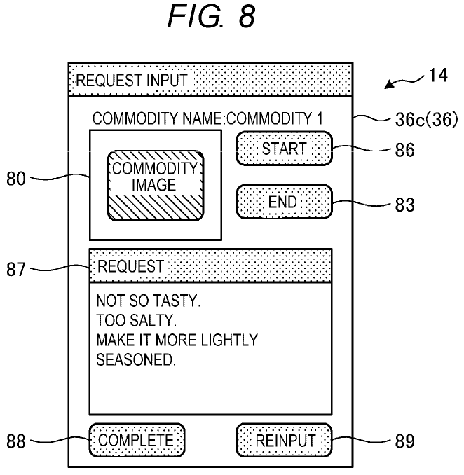

A method of inputting a request for a commodity is explained with reference to FIGS. 6 to 8. FIG. 6 is an example of a screen displayed on the portable terminal and showing a result of object recognition. FIG. 7 is an example of a screen showing commodity information of a recognized commodity. FIG. 8 is an example of a screen showing a request input by voice.

In the store, the customer searches for a commodity for which the customer desires to input a request and photographs an image of the commodity with the camera 38 of the portable terminal 14. The image acquiring unit 63 of the portable terminal 14 acquires the photographed image. The input-information transmitting unit 67 transmits the image of the commodity acquired by the portable terminal 14 to the store server 12.

The input-information acquiring unit 43 of the store server 12 acquires the image of the commodity transmitted from the portable terminal 14. The object recognizing unit 44 performs object recognition on the image acquired by the input-information acquiring unit 43 and uniquely specifies the commodity. The recognition-result transmitting unit 47 transmits a recognition result by the object recognizing unit 44 to the portable terminal 14.

The recognition-result acquiring unit 68 of the portable terminal 14 acquires, from the store server 12, the recognition result of the image of the commodity by the object recognizing unit 44. The recognition-result confirming unit 69 causes the display control unit 75 to display a commodity selection screen 36a illustrated in FIG. 6 on the monitor 36 of the portable terminal 14.

On the commodity selection screen 36a, a commodity image 80, a commodity candidate list 81, a determination button 82, and an end button 83 are displayed.

The customer selects a commodity of a correct candidate out of commodity candidates displayed in the commodity candidate list 81. The operation control unit 76 detects operation on the touch panel 37 by the customer to thereby detect the selected commodity. The operation control unit 76 further detects that the determination button 82 is pressed to thereby uniquely determine the commodity. Thereafter, if it is detected that the end button 83 is pressed, the display control unit 75 erases the commodity selection screen 36a. The recognition-confirmation-result transmitting unit 70 transmits a name of the uniquely determined commodity to the store server 12.

The customer can obtain various kinds of information relating to the uniformly determined commodity by connecting the portable terminal 14 to the Internet. FIG. 7 is an example of a commodity information screen 36b displayed on the monitor 36 of the portable terminal 14 in this way.

On the commodity information screen 36b, the commodity image 80, commodity information 84, a request input button 85, and the end button 83 are displayed. The name of the uniquely determined commodity is displayed above the commodity image 80.

The customer can browse various kinds of information displayed in the commodity information 84. If the customer desires to input a request for the uniquely determined commodity, the customer presses the request input button 85. If the operation control unit 76 detects the pressing of the request input button 85, the display control unit 75 displays a request input screen 36c illustrated in FIG. 8 on the monitor 36. If the end button 83 is pressed on the commodity information screen 36b, considering that the customer does not intend to input a request, the portable terminal 14 ends the processing.

On the request input screen 36c, the commodity image 80, a start button 86, the end button 83, a request display window 87, a completion button 88, and a reinput button 89 are displayed.

If the start button 86 is pressed, the voice acquiring unit 65 acquires, with the microphone 39, a request of the customer for the commodity as a voice signal. The voice acquiring unit 65 continues the acquisition of the voice signal until the end button 83 is pressed.

If the end button 83 is pressed, the input-information transmitting unit 67 transmits the acquired voice signal to the store server 12.

The input-information acquiring unit 43 of the store server 12 acquires the voice signal transmitted from the portable terminal 14. The voice recognizing unit 45 performs voice recognition on the voice signal acquired by the input-information acquiring unit 43. The text analyzing unit 46 performs a syntax analysis of a result of the recognition by the voice recognizing unit 45 to thereby write the result as a sentence. Thereafter, the recognition-result transmitting unit 47 transmits the recognition result by the voice recognizing unit 45 and the text analyzing unit 46 to the portable terminal 14.

The recognition-result acquiring unit 68 of the portable terminal 14 acquires, from the store server 12, the recognition result of the voice signal by the voice recognizing unit 45 and the text analyzing unit 46. The recognition-result confirming unit 69 causes the display control unit 75 to display the recognition result on the request display window 87.

If the recognition result displayed on the request display window 87 is correct, the customer presses the completion button 88. If the operation control unit 76 detects that the completion button 88 is pressed, the display control unit 75 erases the request input screen 36c. The recognition-confirmation-result transmitting unit 70 transmits an indication indicating that the recognition result of the voice signal is correct to the store server 12.

If the recognition result displayed on the request display window 87 is wrong, the customer presses the reinput button 89. If the reinput button 89 is pressed, the recognition result displayed on the request display window 87 is erased. A voice input can be performed again. The customer presses the start button 86 again and utters a request for a commodity. Thereafter, the processing explained above is repeated.

Although not illustrated, the request of the customer may be input by a text input. If the voice recognition is wrong, the customer may correct the recognition result displayed on the request display window 87 by himself or herself by editing the recognition result into a text.

Method of Analyzing a Request for a Commodity:

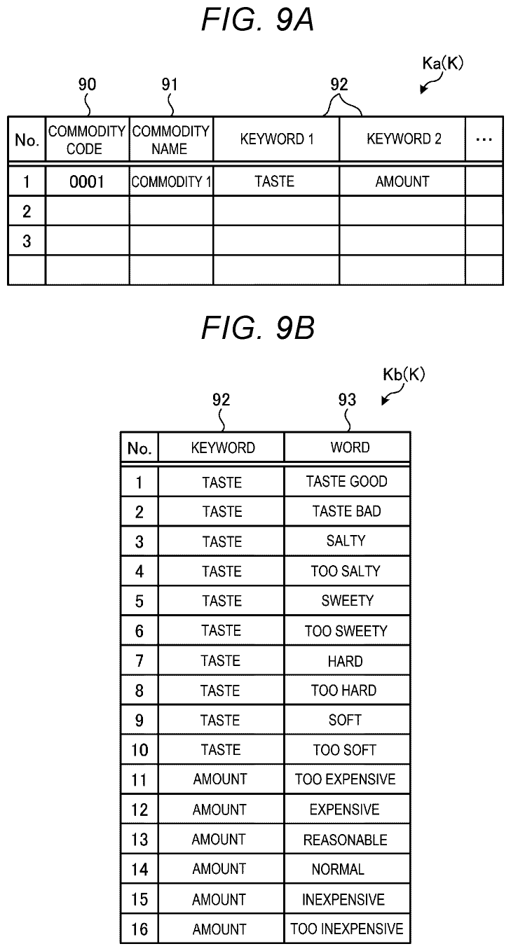

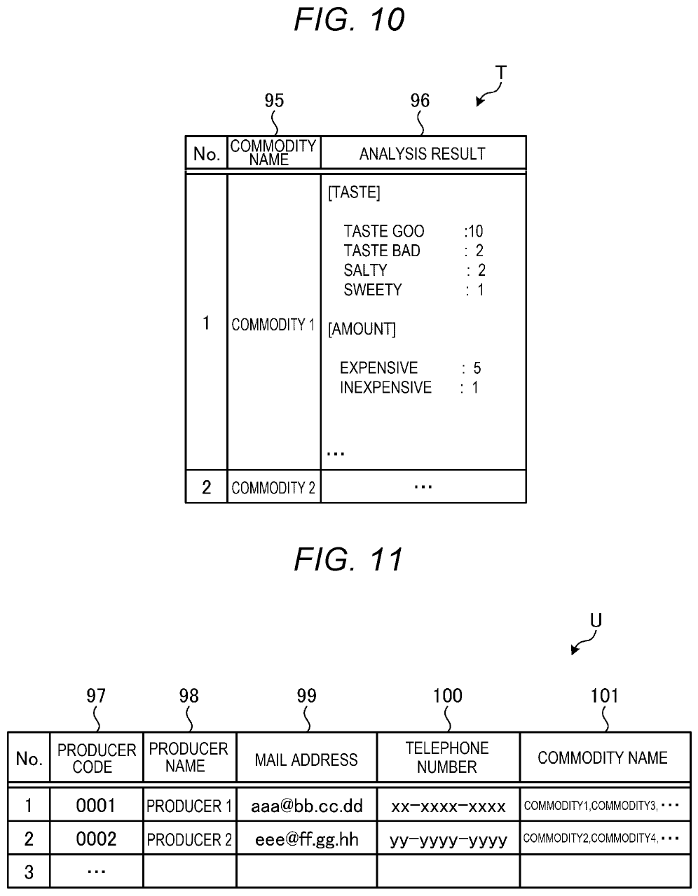

A method of analyzing a request for a commodity is explained with reference to FIGS. 9A to 10. FIGS. 9A and 9B are diagrams illustrating an example of words registered in order to perform an analysis of a request. FIG. 10 is a diagram illustrating an example of an analysis result of the request.

Words registered in order to analyze a request of the customer are registered in the keyword file K explained above. The keyword file K includes an attribute file Ka illustrated in FIG. 9A and a word file Kb illustrated in FIG. 9B.

The attribute file Ka is a file in which attributes of words are registered for each commodity. In the attribute file Ka, a commodity code 90, a commodity name 91, and keyword attributes 92 are correlated with one another and registered.

The word file Kb is a file in which specific words 93 corresponding to attributes of words are registered. In the word file Kb, the keyword attributes 92 and the specific words 93 are correlated with each other and registered. The words 93 are an example of the keyword in the present disclosure. In the words 93, an affirmative word and a negative word are registered for each of the attributes 92. A flag indicating the affirmative word and a flag indicating the negative word may be given to the words 93 registered in the word file Kb.

The request analyzing unit 49 of the store server 12 extracts the word 93 registered in the word file Kb out of an input request of the customer. Further, the request analyzing unit 49 analyzes requests of a plurality of customers for the same commodity to thereby calculate an appearance frequency of the word 93.

FIG. 10 illustrates an example of an analysis result by the request analyzing unit 49. In the request analysis file T, as illustrated in FIG. 10, a result obtained by analyzing a plurality of requests concerning a commodity 1 is stored.

In the request analysis file T, a commodity name 95 and an analysis result 96 of requests for commodities are correlated with each other and stored. In the commodity name 95, names of commodities for which requests are made are stored. In general, the commodity names are stored in a form of commodity codes in order to facilitate data management.

In the analysis result 96, for each of attributes such as a taste and an amount, appearance frequencies of a plurality of words 93 correlated with the attributes are stored. Although not illustrated in FIG. 10, the number of customers requesting the commodities may be further stored. Appearance frequencies of the affirmative words 93 and appearance frequencies of the negative words 93 may be converted into numerical values.

Method of Transmitting a Request for a Commodity

A method of transmitting a request for a commodity is explained with reference to FIG. 11. FIG. 11 is a diagram illustrating an example of a list of producers, which are transmission destinations of requests.

The producer list is managed by the transmission destination file U. In the transmission destination file U, a producer code 97, a producer name 98, a mail address 99, a telephone number 100, and a commodity name 101 are correlated with one another and stored.

The producer code 97 indicates identification numbers for uniquely specifying producers.

The producer name 98 indicates names of the producers.

The mail address 99 indicates mail addresses for transmitting requests to the producers.

The telephone number 100 indicates telephone numbers of the producers.

The commodity name 101 indicates names of commodities produced by the producers. In general, the commodity names are stored in a form of commodity codes.

The request transmitting unit 50 of the store server 12 accesses, at periodic timing such as once a month, the request analysis result stored in the request analysis file T. The request transmitting unit 50 compares and refers to the request analysis file T and the transmission destination file U to thereby specify producers of commodities for which requests are made stored in the request analysis file T.

The request transmitting unit 50 transmits the analysis result 96 stored in the request analysis file T to mail addresses of the specified producers. The request transmitting unit 50 resets the analysis result 96 transmitted to the producers by mail in the analysis result 96 of the request analysis file T.

Flow of Processing Performed by the Request Analysis System:

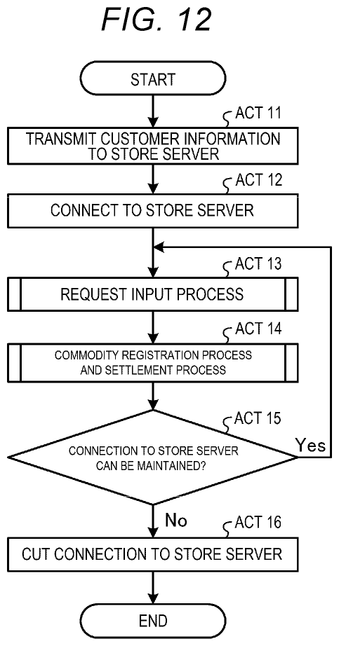

A flow of processing performed by the request analysis system 10 is explained with reference to FIGS. 12 to 16.

Flow of Processing Performed by the Portable Terminal

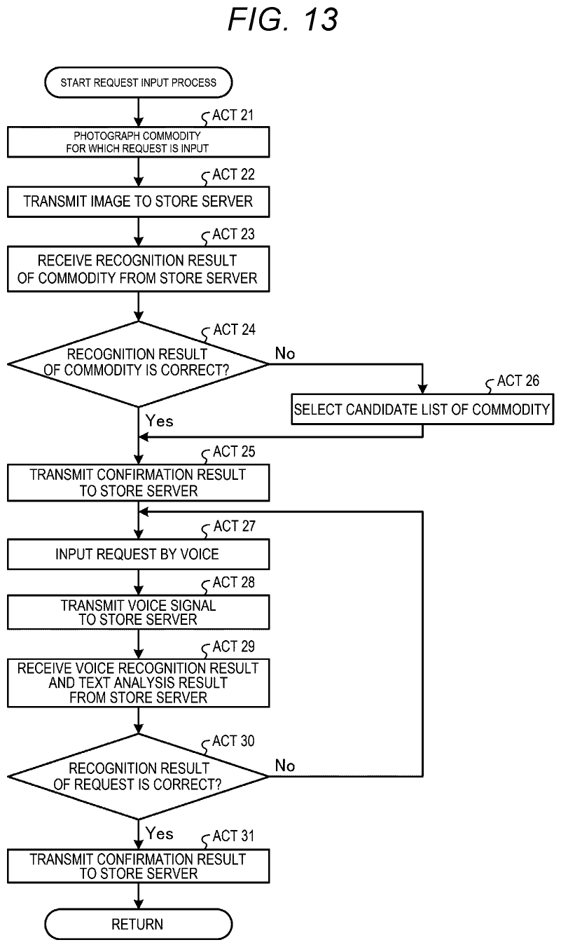

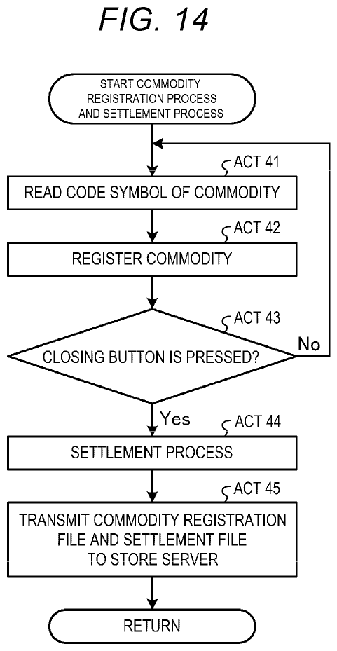

First, a flow of processing performed by the portable terminal 14 is explained with reference to FIGS. 12 to 14. FIG. 12 is a flowchart illustrating an example of a flow of processing performed by the portable terminal in at least one embodiment. FIG. 13 is a flowchart illustrating an example of a flow of a request input process performed by the portable terminal. FIG. 14 is a flowchart illustrating an example of a commodity registering process and a settlement process performed by the portable terminal.

First, a flow of overall processing performed by the portable terminal 14 is explained with reference to FIG. 12.

The customer-information transmitting unit 62 transmits customer information to the store server 12 wirelessly connected to the portable terminal 14 (ACT 11).

If the customer information is authenticated, the communication connecting unit 61 establishes wireless connection between the portable terminal 14 and the store server 12 (ACT 12).

Thereafter, the portable terminal 14 performs a request input process for acquiring a request of the customer (ACT 13). Details of the request input process are explained below (see FIG. 13).

The portable terminal 14 performs a commodity registering process and a settlement process in shopping by the customer (ACT 14). Details of the commodity registering process and the settlement process are explained below (see FIG. 14).

The communication connecting unit 61 determines whether the wireless connection between the portable terminal 14 and the store server 12 can be maintained (ACT 15). If the communication connecting unit 61 determines that the wireless connection between the portable terminal 14 and the store server 12 can be maintained (Yes in ACT 15), the processing returns to ACT 13. On the other hand, if the communication connecting unit 61 does not determine that the wireless connection between the portable terminal 14 and the store server 12 can be maintained (No in ACT 15), the processing proceeds to ACT 16.

If the communication connecting unit 61 does not determine in ACT 15 that the wireless connection between the portable terminal 14 and the store server 12 can be maintained, the communication connecting unit 61 cuts the wireless connection between the portable terminal 14 and the store server 12 (ACT 16). Thereafter, the portable terminal 14 ends the processing illustrated in FIG. 12.

Flow of the Request Input Process Performed by the Portable Terminal:

A flow of the request input process performed by the portable terminal 14 is explained with reference to FIG. 13.

The image acquiring unit 63 photographs, with the camera 38 of the portable terminal 14, a commodity for which a request is made (ACT 21).

The input-information transmitting unit 67 transmits the image of the commodity acquired by the portable terminal 14 to the store server 12 (ACT 22).

The recognition-result acquiring unit 68 acquires, from the store server 12, a recognition result of the image of the commodity by the object recognizing unit 44 of the store server 12 (ACT 23).

The recognition-result confirming unit 69 determines whether the recognition result of the commodity is correct (ACT 24). Specifically, the recognition-result confirming unit 69 displays, on the monitor 36, the recognition result of the commodity acquired by the recognition-result acquiring unit 68 and requests the customer to confirm the recognition result (see FIG. 6). The recognition-result confirming unit 69 acquires a confirmation result of the customer. If the recognition-result confirming unit 69 determines in ACT 24 that the recognition result of the commodity is correct (Yes in ACT 24), the processing proceeds to ACT 25. On the other hand, if the recognition-result confirming unit 69 does not determine that the recognition result of the commodity is correct (No in ACT 24), the processing proceeds to ACT 26.

If the recognition-result confirming unit 69 does not determine in ACT 24 that the recognition result of the commodity is correct, the operation control unit 76 causes the customer to select the commodity candidate list 81 (see FIG. 6) (ACT 26). Thereafter, the processing proceeds to ACT 25.

If the recognition-result confirming unit 69 determines in ACT 24 that the recognition result of the commodity is correct or the commodity is selected out of the commodity candidate list 81 in ACT 26, the recognition-confirmation-result transmitting unit 70 transmits a confirmation result to the store server 12 (ACT 25).

Subsequently, the voice acquiring unit 65 acquires, with the microphone 39 of the portable terminal 14, the request of the customer for the commodity as a voice signal (ACT 27).

The input-information transmitting unit 67 transmits the acquired voice signal to the store server 12 (ACT 28).

The recognition-result acquiring unit 68 acquires, from the store server 12, a recognition result of the request of the customer by the voice recognizing unit 45 and the text analyzing unit 46 (ACT 29).

The recognition-result confirming unit 69 determines whether the recognition result of the request of the customer is correct (ACT 30). Specifically, the recognition-result confirming unit 69 displays, on the monitor 36, the recognition result of the request of the customer acquired by the recognition-result acquiring unit 68 and requests the customer to confirm the recognition result (see FIG. 8). The recognition-result confirming unit 69 acquires a confirmation result of the customer. If the recognition-result confirming unit 69 determines in ACT 30 that the recognition result of the request of the customer is correct (Yes in ACT 30), the processing proceeds to ACT 31. On the other hand, if the recognition-result confirming unit 69 does not determine that the recognition result of the request of the customer is correct (No in ACT 30), the processing returns to ACT 27. The portable terminal 14 causes the customer to input a request for a commodity again. It is determined according to pressing of the completion button 88 illustrated in FIG. 8 that the recognition result of the request of the customer is correct.

If the recognition-result confirming unit 69 determines in ACT 30 that the recognition result of the request of the customer is correct, the recognition-confirmation-result transmitting unit 70 transmits an indication indicating that the recognition result of the request of the customer is correct to the store server 12 (ACT 31). Thereafter, the processing returns to ACT 14 in FIG. 12.

Flow of the Commodity Registering Process and the Settlement Process Performed by the Portable Terminal:

A flow of the commodity registering process and the settlement process performed by the portable terminal 14 is explained with reference to FIG. 14.

The code-symbol reading unit 71 reads a code symbol such as a barcode attached to a commodity to be purchased by the customer (ACT 41).

The commodity-registration processing unit 72 collates a commodity code recorded in the code symbol read by the code-symbol reading unit 71 and the commodity master M to thereby uniquely specify the commodity to be purchased by the customer. The commodity-registration processing unit 72 registers the uniquely specified commodity as a purchased commodity (ACT 42). More specifically, the commodity-registration processing unit 72 transmits the code symbol read by the code-symbol reading unit 71 to the store server 12. The store server 12 collates the commodity code and the commodity master M and uniquely specifies the commodity. The commodity-registration processing unit 72 receives information concerning the uniquely specified commodity from the store server 12 to thereby perform commodity registration. The registered commodity information is stored in the commodity registration file R. The portable terminal 14 may acquire the commodity master M from the store server 12 and specify the commodity on the inside of the portable terminal 14.

The operation control unit 76 determines whether the closing button allocated to the touch panel 37 is pressed (ACT 43). If the operation control unit 76 determines that the closing button is pressed (Yes in ACT 43), the processing proceeds to ACT 44. On the other hand, if the operation control unit 76 does not determine that the closing button is pressed (No in ACT 43), the processing returns to ACT 41.

If the operation control unit 76 determines in ACT 43 that the closing button is pressed, the settlement processing unit 73 performs the settlement process relating to the commodity registered by the commodity-registration processing unit 72 (ACT 44). A result of the settlement process is recorded in the settlement file S.

The purchase-information transmitting unit 74 transmits the commodity registration file R and the settlement file S to the store server 12 (ACT 45). Thereafter, the processing returns to ACT 15 in FIG. 12.

Flow of Processing Performed by the Store Server:

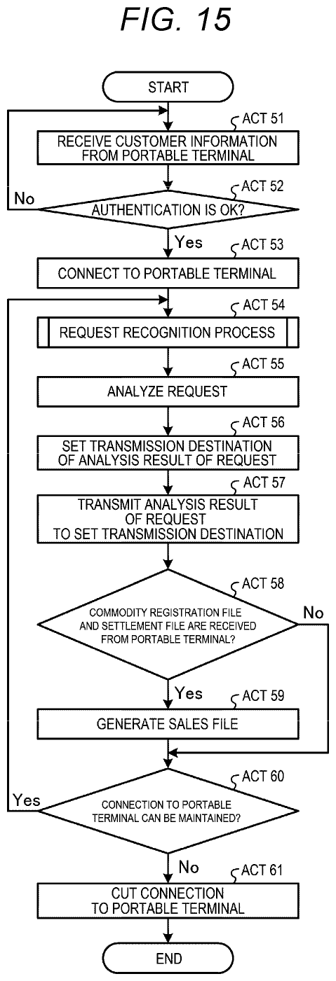

A flow of processing performed by the store server 12 is explained with reference to FIG. 15. FIG. 15 is a flowchart illustrating an example of a flow of processing performed by the store server in at least one embodiment.

The customer-information acquiring unit 42 acquires customer information transmitted from the portable terminal 14 (ACT 51).

The customer-information acquiring unit 42 determines based on the acquired customer information whether the customer is a member of the store (ACT 52). If the customer-information acquiring unit 42 determines that the customer is a member of the store, that is, authentication is OK (Yes in ACT 52), the processing proceeds to ACT 53. On the other hand, if the customer-information acquiring unit 42 does not determine that the customer is a member of the store, that is, authentication is OK (No in ACT 52), the processing returns to ACT 51.

If the customer-information acquiring unit 42 determines in ACT 52 that the customer is a member of the store, the communication connecting unit 41 establishes wireless connection between the store server 12 and the portable terminal 14 (ACT 53).

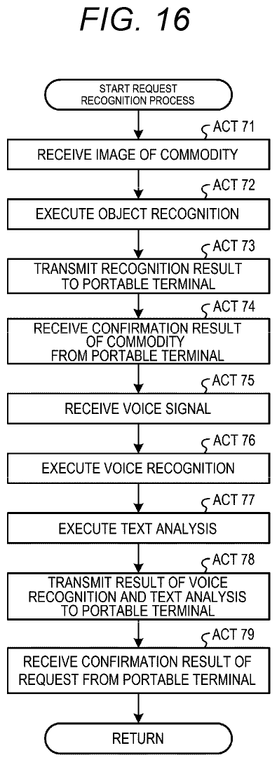

Subsequently, the store server 12 performs a request recognizing process for recognizing a request of the customer input by the portable terminal 14 (ACT 54). Details of the request recognizing process are explained below (see FIG. 16).

The request analyzing unit 49 analyzes, for each commodity, an appearance frequency of a preset word included in the request of the customer (ACT 55).

The request transmitting unit 50 sets a transmission destination of an analysis result of the request by the request analyzing unit 49 (ACT 56).

The request transmitting unit 50 transmits the analysis result of the request to the transmission destination set in ACT 56 (ACT 57).

The purchase-information acquiring unit 51 determines whether the commodity registration file R and the settlement file S are acquired from the portable terminal 14 (ACT 58). If the purchase-information acquiring unit 51 determines that the commodity registration file R and the settlement file S are acquired (Yes in ACT 58), the processing proceeds to ACT 59. On the other hand, if the purchase-information acquiring unit 51 does not determine that the commodity registration file R and the settlement file S are acquired (No in ACT 58), the processing proceeds to ACT 60.

If determining in ACT 58 that the commodity registration file R and the settlement file S are acquired, the purchase-information acquiring unit 51 generates the sales file F (ACT 59).

The communication connecting unit 41 determines whether the wireless connection between the store server 12 and the portable terminal 14 can be maintained (ACT 60). If the communication connecting unit 41 determines that the wireless connection between the store server 12 and the portable terminal 14 can be maintained (Yes in ACT 60), the processing returns to ACT 54. On the other hand, if the communication connecting unit 41 does not determine that the wireless connection between the store server 12 and the portable terminal 14 can be maintained (No in ACT 60), the processing proceeds to ACT 61.

If not determining in ACT 60 that the wireless connection between the store server 12 and the portable terminal 14 can be maintained, the communication connecting unit 41 cuts the wireless connection between the store server 12 and the portable terminal 14 (ACT 61). The store server 12 ends the processing illustrated in FIG. 15.

Flow of the Request Recognizing Process Performed by the Store Server:

A flow of the request recognizing process performed by the store server 12 is explained with reference to FIG. 16.

The input-information acquiring unit 43 receives an image of a commodity photographed by the portable terminal 14 (ACT 71).

The object recognizing unit 44 executes object recognition on the image of the commodity received in ACT 71 (ACT 72).

The recognition-result transmitting unit 47 transmits a result of the object recognition to the portable terminal 14 (ACT 73).

The recognition-confirmation-result acquiring unit 48 receives a confirmation result of the customer for the recognition result of the commodity received from the portable terminal 14 (ACT 74).

Subsequently, the input-information acquiring unit 43 receives a voice signal of the customer acquired by the portable terminal 14 (ACT 75).

The voice recognizing unit 45 executes voice recognition on the acquired voice signal (ACT 76).

The text analyzing unit 46 executes a text analysis to thereby write, as a sentence, the request of the customer recognized by the voice recognizing unit 45 (ACT 77).

The recognition-result transmitting unit 47 transmits a result of the processing performed by the voice recognizing unit 45 and the text analyzing unit 46 to the portable terminal 14 (ACT 78).

The recognition-confirmation-result acquiring unit 48 receives a confirmation result of the request from the portable terminal 14 (ACT 79). Thereafter, the processing returns to ACT 55 in FIG. 15.

In the above explanation, the portable terminal 14 transmits the acquired image and the acquired voice signal to the store server 12. The store server 12 performs the object recognition, the voice recognition, and the text analysis. However, by compactly configuring an engine that performs the various kinds of recognition processing and the object recognition dictionary D1, the voice recognition dictionary D2, and the syntax analysis dictionary D3, the engine and the dictionaries may be implemented in the portable terminal 14. By adopting such a configuration, the portable terminal 14 may be capable of recognizing the request of the customer in the portable terminal 14.

As explained above, in the store server 12 (the information processing apparatus) in at least one embodiment, the input-information acquiring unit 43 (the acquiring unit) correlates a request of the customer for a commodity with information (for example, an image, a commodity code, and a commodity name of the commodity) for specifying the commodity for which the request is made and acquires the request. The request analyzing unit 49 (the analyzing unit) analyzes, for each commodity, the request acquired by the input-information acquiring unit 43 based on whether a preset keyword is included in the request. The request transmitting unit 50 (the transmitting unit) transmits an analysis result by the request analyzing unit 49 to a transmission destination (for example, a producer of the commodity) correlated with the commodity. Therefore, it is possible to correlate a commodity and a request of the customer for the commodity and easily acquire the request in a form desired by the producer.

In the store server 12 (the information processing apparatus) in at least one embodiment, the input-information acquiring unit 43 (the acquiring unit) correlates a request of the customer for a commodity with an image of the commodity for which the request is made photographed by the portable terminal 14 carried by the customer and acquires the request. Therefore, the store server 12 can perform, for example, object recognition and recognize the commodity. Therefore, it is possible to easily and surely uniquely specify the commodity for which the request is made.

In the store server 12 (the information processing apparatus) in at least one embodiment, the request analyzing unit 49 (the analyzing unit) calculates the number of appearances of the word 93 (the keyword) included in the request for the commodity. Therefore, it is possible detect, with simple processing, the request of the customer and content of the request.

In the store server 12 (the information processing apparatus) in at least one embodiment, the request analyzing unit 49 (the analyzing unit) calculates the number of appearances of each of an affirmative keyword and a negative keyword included in the request for the commodity. Therefore, it is possible to easily determine, according to the calculated number of appearances of the keyword, whether an affirmative request is made or a negative request is made. Consequently, it is possible to improve efficiency in putting a large number of requests in order.

In the store server 12 (the information processing apparatus) in at least one embodiment, the input-information acquiring unit 43 (the acquiring unit) acquires the request of the customer by voice. Therefore, even a customer unaccustomed to an information device can easily transmit a request for a commodity.

The embodiment is explained above. However, this embodiment is presented as an example and is not intended to limit the scope of the invention. This new embodiment can be implemented in other various forms. Various omissions, substitutions, and changes can be made without departing from the spirit of the invention. This embodiment and modifications of the embodiment are included in the scope and the gist of the invention and included in the inventions described in claims and the scope of equivalents of the inventions.

What is claimed is:

1. An information processing apparatus comprising:
a controller configured to:
correlate a request of a customer for a commodity with information for specifying the commodity for which the request is made;
acquire the request;
analyze, for each the commodity, the request acquired based on whether a preset keyword is included in the request; and
transmit an analysis result to a transmission destination correlated with the commodity.

2. The apparatus of claim 1, wherein the controller is further configured to correlate the request of the customer for the commodity with an image of the commodity for which the request is made, wherein the image is a photograph by a portable terminal carried by the customer.

3. The apparatus of claim 1, wherein the controller is further configured to calculate a number of appearances of the keyword included in the request for the commodity.

4. The apparatus of claim 3, wherein the controller is further configured to calculate a number of appearances of each of an affirmative keyword and a negative keyword included in the request for the commodity.

5. The apparatus of claim 1, wherein the request is made by the customer by voice.

6. The apparatus of claim 5, wherein the controller is further configured to perform a syntax analysis of the request of the customer by voice.

7. The apparatus of claim 6, wherein the controller is configured to cause a display of the request of the customer by voice as a written sentence on a request display window.

8. An information processing method comprising:
correlating a request of a customer for a commodity with information for specifying the commodity for which the request is made and acquiring the request;
analyzing, for each the commodity, the acquired request based on whether a preset keyword is included in the request; and
transmitting a result of the analysis to a transmission destination correlated with the commodity.

9. The method of claim 8, further comprising correlating the request of the customer for the commodity with an image of the commodity for which the request is made, wherein the customer generates the image by taking a photograph with a portable terminal carried by the customer.

10. The method of claim 8, further comprising calculating a number of appearances of the keyword included in the request for the commodity.

11. The method of claim 10, further comprising calculating a number of appearances of each of an affirmative keyword and a negative keyword included in the request for the commodity.

12. The method of claim 8, further comprising acquiring the request of the customer by voice.

13. The method of claim 12, further comprising performing a syntax analysis of the request of the customer by voice.

14. The method of claim 13, further comprising causing a display of the request of the customer by voice as a written sentence on a request display window.
